(19) United States
(12) Patent Application Publication
(10) Pub. No.: US 2009/0043856 A1
(43) Pub. Date: Feb. 12, 2009

(54) Instant Messenger with Visible Attributes on the Presence Line

(75) Inventor: Kevin Darby, Fenton, MO (US)

Correspondence Address: AT&T Legal Department, Attn: Patent Docketing, Attn: Patent Docketing Room 2A- 207, One AT & T Way, Bedminster, NJ, 07921, US

(73) Assignee: AT&T KNOWLEDGE VENTURES, LP, Reno, NV (US)

(21) Appl. No.: 11/836,558

(22) Filed: Aug. 9, 2007

(51) Int. Cl. G06F 15/16

(52) U.S. Cl. 709/206

(57) ABSTRACT

An instant messaging system comprising a user interface and a plurality of indicia. The user interface displays the indicia including a potential recipient of an instant message, and a plurality of attributes representing an area of expertise for the potential recipient. A method for displaying the user interface and the indicia is also disclosed.

### FIELD OF THE DISCLOSURE

This invention generally relates to electronic communications, and more particularly relates to visible attributes for an instant messenger.

### BACKGROUND

Presence and availability are terms used to describe a present ability of an individual to communicate. Presence is an ability of an individual to communicate in real time, and availability is the willingness of an individual to communicate in real time. In communications, it is advantageous to know whether a potential recipient of a communication message is present and available, i.e., available to receive and respond to the message before initiating the transmission of the message. By making the presence and availability of individual users known before any communication is attempted, a realtime communications environment is facilitated that is more effective and less obtrusive than conventional communication mediums. Clearly, the communication message that is sent to an addressee that is known to be present and available is more likely to be received promptly than a conventional message. For example, conventional telephone calls often are forwarded to a person's voicemail but never returned.

Instant messaging (IM) is one communication medium that employs presence and availability technology. An instant messaging network recognizes when a user is “present” on the network. Accordingly, the network sends notification to other users (usually members of a “buddy list”) that are also logged on the network that the user is “present.” Further, instant messaging lets a user display custom status messages to his “buddies” online about the user's “availability.” For example, a user can specify his availability status as being “busy, not taking messages.” Therefore another user on the “buddy list” that is connected to the instant messaging network will be notified that although the user is present on the network, he is not available for receiving messages. Presence and availability information is most useful when an individual shares his or her online status with a trusted group of users. A communication message sent to someone who is readily present and available is less obtrusive when the addressee has made himself or herself available to the communication.

One way that a user can be notified to the online presence or availability of another user through instant messaging is to set up an auditory alert mechanism or “buddy alert.” Typically, a user via an IM client will set parameters consisting of the people that the user wants to monitor and what sound the user wants his or her instant messaging client to play when the presence or availability status of a monitored user changes. For example, a user, Dale, may want to be notified when his friend, Lee, is connected to the instant messaging network. Therefore, Dale may designate parameters in his contact list that an auditory alert should be played on Dale's instant messaging client when Lee comes online. In the parameters, Dale can also assign a unique sound to this “buddy” by associating a particular audio file to this alarm request. Accordingly, Dale could assign a particular auditory alert to be played for each “buddy” he monitors. Therefore, when Lee connects to the instant messaging network, an auditory alert will play on Dale's client to notify him of Lee's online presence.

Today's instant messaging services mostly focus on the generation of auditory alerts for a user who is monitoring presence status changes initiated by persons named in the contact list of the user. The monitoring user designates the type of auditory alert played and under what conditions the auditory alert is played. Such conventional monitoring techniques are not flexible for the user being monitored. For example, conventional monitoring techniques do not enable monitoring of a user at different addresses.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a network with a plurality of work groups;

FIG. 2 is a screen shot of an instant message contact list;

FIG. 3 is a block diagram of a list of user presence indicia;

FIG. 4 is a block diagram of a peer-to-peer instant message network;

FIG. 5 is a block diagram of an instant message network with a processing module;

FIG. 6 is a flow chart of a method for displaying and using a list of user presence indicia;

FIG. 7 is a flow chart of a method for sending an instant message by a peer-to-peer connection;

FIG. 8 is a flow chart of a method for sending an instant message through a central instant message module; and

FIG. 9 is a block diagram of a of a data processing device.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

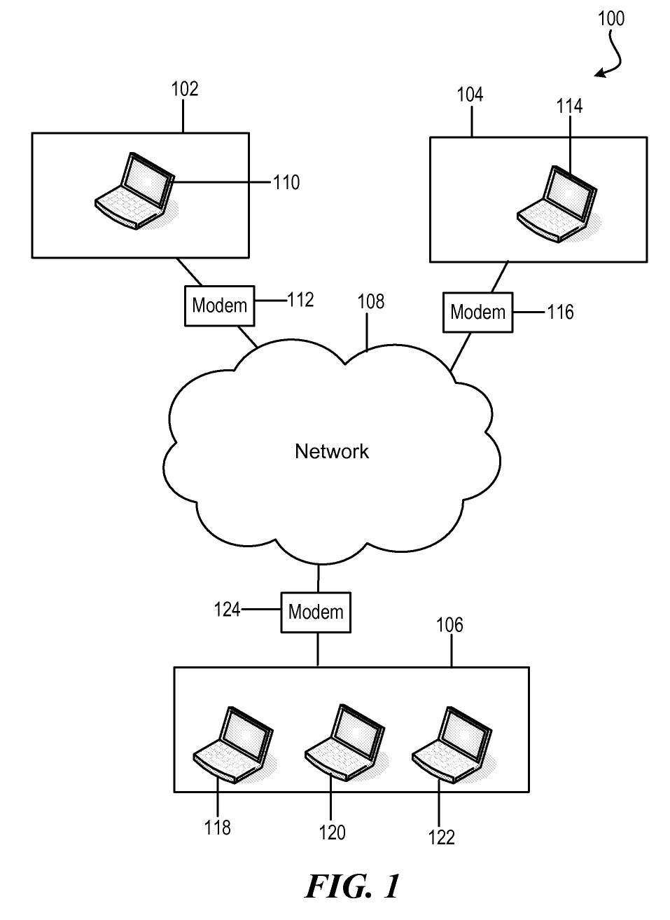

FIG. 1 shows a block diagram of a communication system 100 including a first workgroup 102, a second workgroup 104, a third workgroup 106, and a network 108. The first workgroup 102 has a first computer 110 and is connected to the network 108 by a modem 112. The second workgroup 104 has a second computer 114 and is connected to the network 108 by a modem 116. The third workgroup 106 has a third computer 118, a fourth computer 120, and a fifth computer 122. The third workgroup 106 is connected to the network 108 by a modem 124. The first workgroup 102 communicates with the second and third workgroups through the network 108. Depending on the size of an organization served by the network, the workgroups may be in different buildings, cities, states, or countries. The number of computers within a workgroup may also vary.

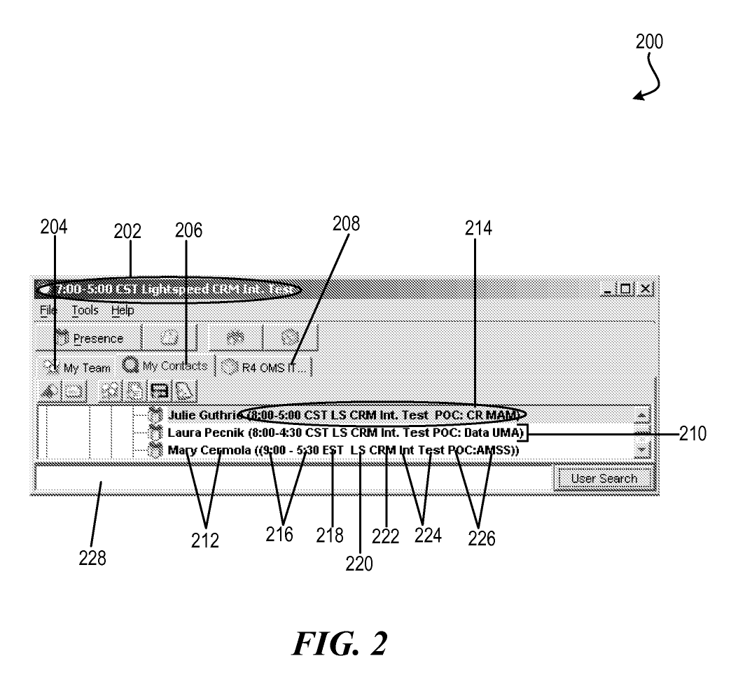

FIG. 2 shows a screen shot of an instant message user interface 200, such as a graphical user interface (GUI), including a presence indicator 202, and a plurality of contact lists including a team tab 204, a contacts tab 206, and a group tab 208. The instant message user interface 200 is preferably displayed on a communication device such as a computer. Each of the contact lists, such as the contacts tab 206, has a plurality of user presence indicia 210. The user presence indicia 210 preferably include a name element 212 and a set of visible attributes 214 for an area of expertise of a user. The visible attributes 214 include a work hours element 216, a time zone element 218, a large application element 220, a small application element 222, a group element 224, and a role element 226.

The presence indicator 202 is located on the top of the instant message user interface 200 and displays the visible attributes 214 for the user of the instant message user interface. The user of the instant message user interface 200 is given the opportunity to update the presence indicator 202 upon either opening the instant messaging user interface or when the user sends a message for the first time. Also, the presence indicator 202 is displayed on the top of the instant message user interface 200 so that the user is able to see if the presence indicator needs to be updated because the user has changed roles, applications, or working hours. As individuals leave or new individuals join a group, the responsibilities for each individual change making the user presence indicia 210 no longer current. Each time the presence indicator 202 is updated, the user presence indicia 210 for the user is updated on the instant message interface 200 of the other users in the system, with the user presence indicia listed as a contact.

The team tab 204, the contacts tab 206, and the group tab 208 preferably have different user presence indicia 210. The team tab 204 includes the user presence indicia 210 of individuals that work on the same team as the user of the instant message user interface 200. Additionally, the contact tab 206 includes the user presence indicia 210 for individuals anywhere in the organization that the user routinely communicates with through the instant message user interface 200. However, the group tab 208 includes the user presence indicia 210 for individuals in a particular group of the organization that the user preferably works closely with and communicates with through the instant message user interface 200. If the user of the instant message user interface 200 has multiple groups that he or she works closely with or communicates with often, multiple group tabs 208 may be displayed in the instant message user interface.

The user presence indicia 210 in the team tab 204, contacts tab 206, and the group tab 208 are affiliated with individuals that the user of the instant message user interface 200 converses with often. A user determines the user presence indicia 210 which to send a message by looking at the name element 212 and the visible attributes 214 of the different user presence indicia. For example, if the user knows the person that he or she wants to contact as a potential recipient for an instant message communication, the name element 212 provides the first and last name of the user. The work hours element 216 and the time zone element 218 visible attributes 214 allow a user to determine the best time for contacting the user presence indicia 210. A workgroup may include individuals in multiple time zones, and therefore communication between group members depends on the time of day in the different time zones. Additionally, a first user of the instant message system may send a message to a second user in which the second user does not have knowledge in the area of the question. The first user may therefore have to send messages to other users until he or she finds someone with knowledge to answer the question.

The visible attributes 214 of the user presence indicia 210 additionally provide information relating to the knowledge and experience of a particular user. If a user has a broad question that anyone in a particular large application is able to answer, the user only has to look at the large application element 220 visible attributes before sending the message. However, if the question is narrow, the small application element 222, the group element 224, and the role element 226 visible attributes 214 enable an individual to closely select the proper user presence indicia 210. Utilizing all of the visible attributes 214 allows a user to determine the likelihood of receiving a response to an instant message. The search field 228 is used to find the user presence indicia 210 or a list of user presence indicia with certain visible attributes, such as a particular small application element 222. For example, if a user has a question for an individual in another group but does not know a person in that group, the employee preferably types the group into the search field 228. The employee then receives a list of the user presence indicia 210 within the group element 224 corresponding to the group searched.

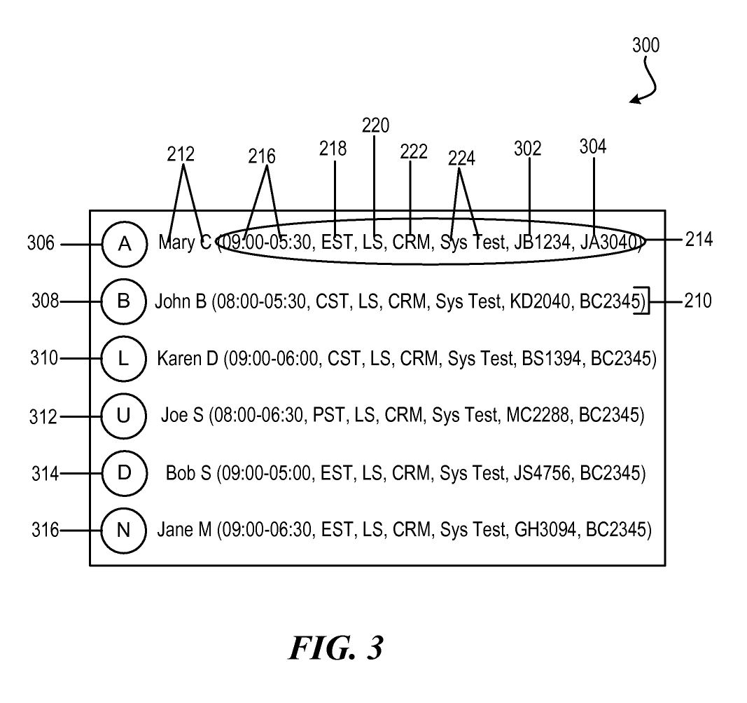

FIG. 3 is a block diagram of an instant message interface 300 including a plurality of user presence indicia 210. The user presence indicia 210 include the name element 212, the work hours element 216, the time zone element 218, the large application element 220, the small application element 222, the group element 224, a friend element 302, and a lead element 304. If the user presence indicia 210 is not available an individual has the ability to contact a user represented by the friend element 302 or the lead element 304 listed in the user presence indicia. The friend element 302 identifies a person that the user presence has selected as a friend with the capability to understand enough on the terminology of the message to response to the sender. The lead element 304 identifies a person in charge of the group element 224 of the user presence indicia 210. Therefore, the user associated with the lead element 304 is another person available to answer a question if the user of the user presence indicia 210 originally contacted is not available. The user presence indicia 210 also include an availability indicator icon 306 which indicates if the user presence is available, busy, has locked the desktop, unavailable, disconnected, or not a frequent user. The availability indicator icon 306 is located next to the name element 212 of the user presence indicia 210 and is preferably colored circles or light bulbs with a large capital letter inside the circle for users that have color impaired vision to represent the availability of the user presence.

The availability indicator icon 306 for an available user is preferably green in color with a capital ‘A’ inside the circle. When a user sees the green color or the ‘A’ next to the user presence indicia 210, the user knows that sending a message to the user of the user presence indicia 210 is likely to get a quick reply. If the user is busy, the availability indicator icon 306 is preferably yellow with a capital ‘B’ to inform someone sending a message that a quick response is not to be expected because the user has manually set the user presence indicia 216 to busy. Upon sending a message to a user of the user presence indicia 210 that is busy, a reply is sent to the sender in the message dialog box, such as user: AB1234 (14:25:28 Busy). The automatic response lists the user identification, the time the message was sent and that the user is busy. The availability indicator icon 306 is preferably dim yellow and has a capital ‘L’ inside the circle to indicate that the user has locked the desktop and stepped away from the computer. Other indicator icons for when the desktop is locked may include a large clock inside the circle or a small red clock on the circle. If the user unavailable, the availability indicator icon 306 is preferably light blue with a capital ‘U’ inside the circle to indicate that the user has manually set the user presence indicia 210 as unavailable. The availability indicator icon 306 is preferably dark blue with a capital ‘D’ inside the circle to indicate that the user presence indicia is disconnected from the instant message server. If the user does not frequently log on to the network, the availability indicator icon 306 is preferably grey with a capital ‘N’ inside the circle to indicate that the user associated with the particular user presence indicia 210 has not logged in for 72 hours or more. The user presence indicia 210 also has the ability to list “OOO mm-dd—mm-dd” along with the last updated user presence indicia to indicate that the user is on vacation and the length of time the user is to be out of the office.

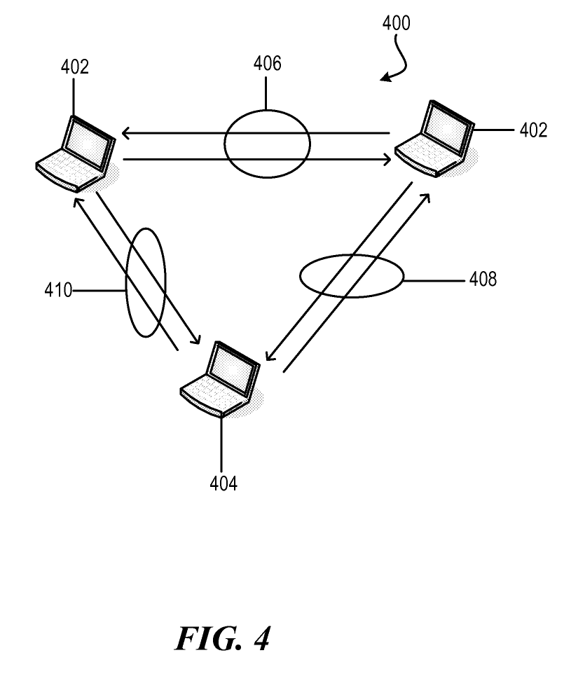

FIG. 4 shows a block diagram of a peer-to-peer computer network 400 including a sending computer 402, a target computer 404, and a friend computer 406, which are preferably connected through a peer-to-peer connection. In the peer-to-peer connection the computers communicate directly. For example, the sending computer 402 is connected with the target computer 404 over a first pair of lines 408, the target computer 404 is connected with the budding computer 406 over a second pair of lines 410, and the sending computer is connected with the friend computer over a third pair of lines 412. If the sending computer 402 sends a message to the target computer 404 and user of the target computer is not available, the target computer automatically forwards the message to the friend computer 406 over the second pair of lines 410. The user of the friend computer 406 replies to the user of the sending computer 402 directly over the third pair of lines 412, without sending the message through the target computer 404.

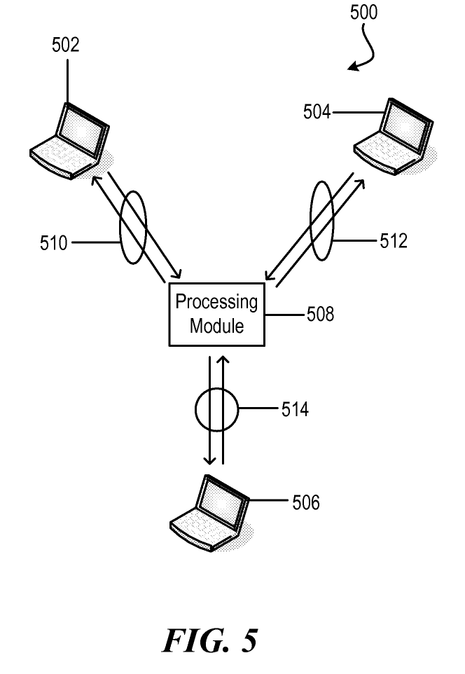

FIG. 5 shows a block diagram of a computer network 500 including a sending computer 502, a target computer 504, a friend computer 506, and a processing module 508. The sending computer 502, the target computer 504, and the friend computer 506 are preferably connected through the processing module 508. The processing module 508 connects with the sending computer 502 over a first pair of lines 510, the target computer 504 over a second pair of lines 512, and the friend computer 506 over a third pair of lines 514. A user of the sending computer 502 sends a message to the user of the target computer 504 over the first pair of lines 510 to the processing module 508. The processing module 508 identifies the target computer and transmits the message to the target computer over the second pair of lines 512.

A reply message sent from the target computer 504 to the sending computer 502 is sent along the same path, but in the reverse direction. However, if the user of the target computer 504 is not available, an unavailable message is sent from the target computer to the processing module 508. Upon receiving the unavailable message, the processing module 508 searches for a friend of the user of the target computer 504. When the processing module 508 identifies the friend, such as the friend computer 506, the processing module forwards the message over the third pair of lines 514 to the friend computer. Any reply message from the friend computer 506 is sent along the third pair of lines 514 to the processing module 508 and then along the first pair of lines 510 to the sending computer 502.

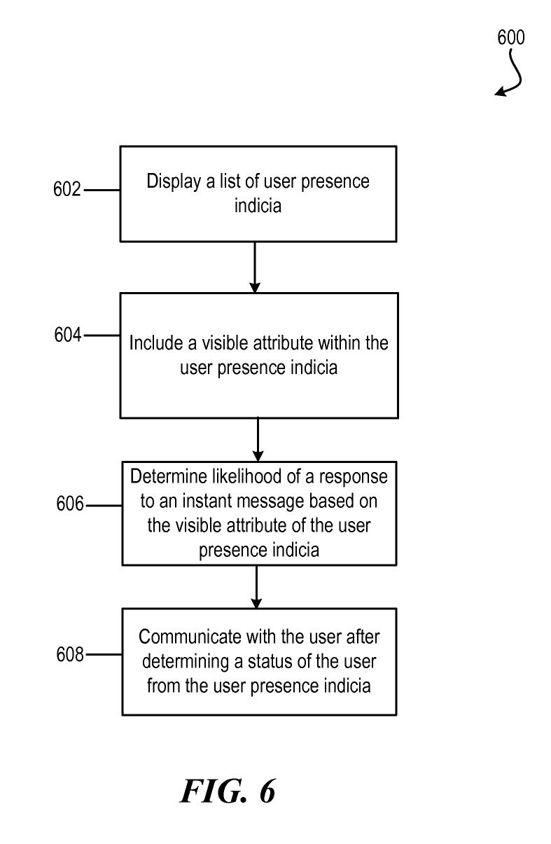

FIG. 6 is a flow chart of a method 600 for using a list of user presence indicia. At block 602, the list of user presence indicia is displayed. A plurality of visible attributes are included with the user presence indicia at block 604. The visible attributes for a user include the typical hours worked, the time zone, the large application, the small application, the group, the role, the friend, and the lead of the user. The visible attributes listed in the user presence indicia provide a sender with information to send a request or message to the proper user. At block 606, a user determines the likelihood of receiving a response to an instant message based on the visible attributes of the user presence indicia. A first user communicates with a second user of a user presence indicia listed after determining a status of the second user from the user presence indicia at block 608.

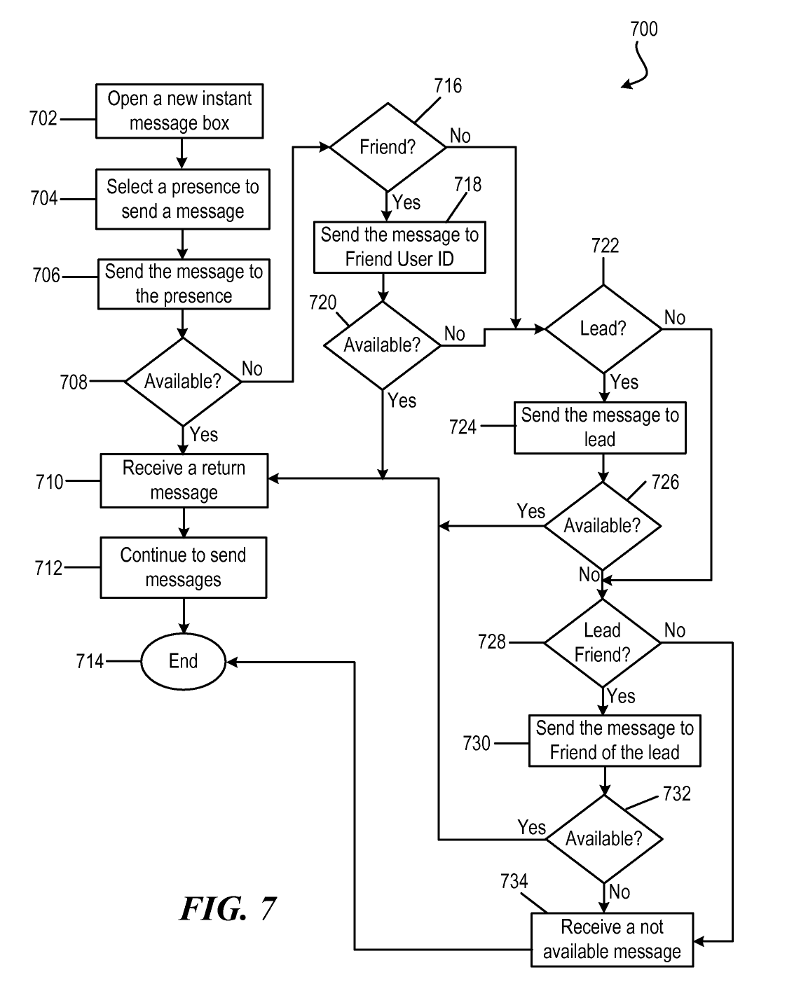

FIG. 7 is a flow chart of a method 700 for sending an instant message by a peer-to-peer connection. At block 702, a new instant message box is opened. The instant message box enables a user to type a message to send to an individual in an instant message system network and to start a dialogue with that individual. A user presence indicia is selected to send a message at block 704. The user presence indicia includes the first and last name of the user, along with additional visible attributes about the user. The visible attributes for a user include the typical hours worked, the time zone, the large application, the small application, the group, the role, the friend and the lead of the user. The visible attributes listed in the user presence indicia provide a sender with information to send a request or message to the proper user. At block 706, the message is sent to the user selected. When the message arrives at the user associated with the user presence indicia a determination is made as to whether the user is available to take the message at block 708. If the user is available, the sender will receive a return message at block 710. At block 712, the sender continues to send and receive messages with the user until the sender gets the information that the sender needed. The message exchange ends at block 714.

However, if the user of the user presence indicia is not available, a check is performed to establish if the user presence indicia has a friend identified at block 716. If the user of the user presence indicia has a friend, the message is sent to the friend at block 718. When the message arrives at the friend, a determination is made as to whether the friend is available to take the message at block 720. If the friend is available, the sender receives a return message at block 710 and the flow continues as stated above. If user does not have a friend or the friend is not available the instant message system checks if the user presence indicia has a lead identified at block 722. If the user of the user presence indicia has a lead, the message is sent to the lead at block 724. When the message arrives at the lead, the instant message system determines whether the lead is available to take the message at block 726. If the lead is available, the sender receives a return message at block 710 and the flow continues as stated above. If the user of the user presence indicia does not have a lead or the lead is not available, a check is performed to establish if the lead has a friend identified at block 728. If the lead has a friend, the message is sent to the friend of the lead at block 730. When the message arrives at the friend of the lead, a determination is made as to whether the friend of the lead is available to take the message at block 732. If the friend of the lead is available, the sender receives a return message at block 710 and the flow continues as stated above. If the lead does not have a friend or the friend of the lead is not available the sender receives a “not available” message at block 734. The message exchange ends at block 714.

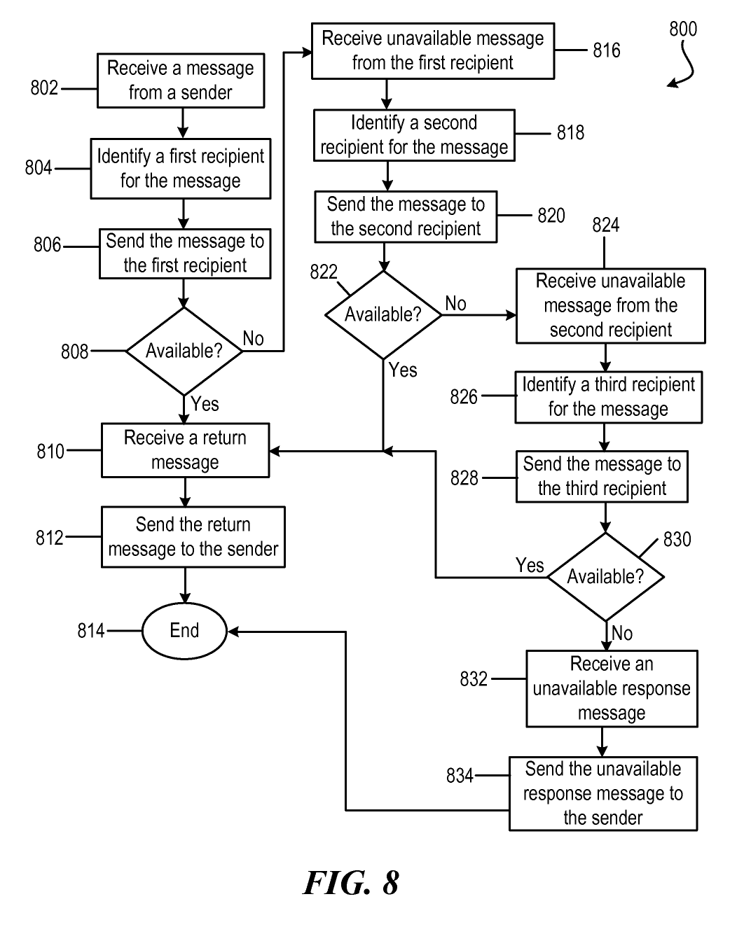

FIG. 8 is a flow chart of a method 800 for sending an instant message through a central instant message module. At block 802, the central instant message module receives a message from a sender. The instant message module identifies a first recipient to send the message at block 804. As stated above, the user presence indicia includes the first and last name of the user along with additional visible attributes about the user. The visible attributes for a user include the typical hours worked, the time zone, the large application, the small application, the group, and the role of the user. The visible attributes listed in the user presence indicia provide a sender with information to send a request or message to the proper user. At block 806, the central instant message module sends the message to the first recipient. When the message arrives at the first recipient, a determination is made as to whether the first recipient is available to take the message at block 808. If the first recipient is available, the central instant message module will receive a return message at block 810. At block 812, the central instant message module sends the return message to the sender. The message exchange ends at block 814.

If the first recipient is not available, the central instant message module receives an unavailable message from the first recipient at block 816. At block 818, the central instant message module identifies a second recipient for the message. The central instant message module sends the message to the second recipient at block 820. The instant message system establishes whether the second recipient is available to take the message at block 822. If the first recipient is available, the central instant message module will receive a return message at block 810 and the flow continues as stated above. If the second recipient is not available the central instant message module receives an unavailable message from the second recipient at block 824. At block 826, the central instant message module identifies a third recipient for the message. The central instant message module sends the message to the third recipient at block 828. A determination is made as to whether the third recipient is available to take the message at block 830. If the third recipient is available, the central instant message module will receive a return message at block 810 and the flow continues as stated above. If the third recipient is not available, the central instant message module receives an unavailable message from the third recipient at block 832. At block 834, the central instant message module sends the sender the unavailable message. The message exchange ends at block 814.

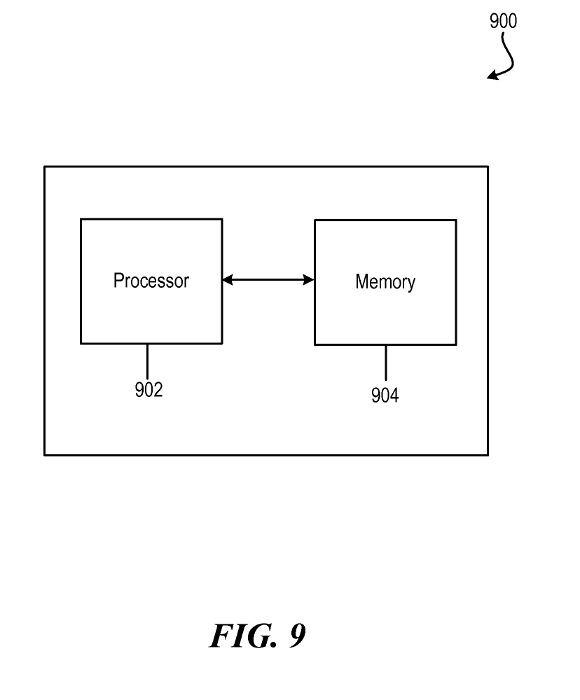

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein. FIG. 9 is a block diagram of a data processing device 900 including a processor 902 and a computer-readable device such as a memory 904. The memory 904 stores a set of instructions to manipulate the processor to perform the methods 600, 700, and 800 of FIGS. 6, 7, and 8 above. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Although the present specification describes components and functions that may be implemented in particular embodiments with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGS. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. An instant messaging system comprising:
a communications device having a user interface; and
a first plurality of indicia displayed on the user interface, the first indicia including a potential recipient of an instant message, and a plurality of attributes representing an area of expertise for the potential recipient.

2. The instant messaging system of claim 1 further comprising a presence indicator displayed on the user interface, the presence indicator including the attributes for a user of the communications device.

3. The instant messaging system of claim 1 wherein the attributes are visible and include a large application name for the potential recipient.

4. The instant messaging system of claim 1 further comprising a search field displayed on the user interface, the search field receives the attributes that a user of the communication device wants to search.

5. The instant messaging system of claim 4 further comprising a second plurality of indicia displayed on the user interface, the second indicia determined based on the attributes entered in the search field.

6. The instant messaging system of claim 1 wherein the attributes are visible and include a friend of the potential recipient.

7. The instant messaging system of claim 6 wherein the instant message is forwarded to the friend of the potential recipient upon determining that the potential recipient is not available.

8. A method comprising:
displaying a user interface on a communications device; and
displaying a first plurality of indicia on the user interface, the first indicia including a potential recipient of an instant message and a plurality of attributes representing an area of expertise for the potential recipient.

9. The method of claim 8 further comprising:
transmitting the instant message from the communications device to the potential recipient.

10. The method of claim 9 wherein the attributes are visible and include a friend of the potential recipient.

11. The method of claim 10 further comprising:
forwarding the instant message to the friend of the potential recipient upon determining that the potential recipient is not available.

12. The method of claim 8 wherein the attributes are visible and include a large application name for the potential recipient.

13. The method of claim 8 further comprising:
displaying a second plurality of indicia based on the attributes entered in a search field.

14. The method of claim 8 wherein the attributes are visible and include a group name for the potential recipient.

15. An instant message system comprising:
a graphical user interface; and
a first plurality of indicia displayed on the graphical user interface, the first indicia including a potential recipient of an instant message, and a plurality of attributes representing an area of expertise for the potential recipient.

16. The instant message system of claim 15 further comprising a presence indicator displayed on the graphical user interface, the presence indicator including the attributes for a user of the graphical user interface.

17. The instant message system of claim 15 wherein the attributes are visible and include a large application name for the potential recipient.

18. The instant message system of claim 15 wherein the attributes are visible and include a small application name for the potential recipient.

19. The instant message system of claim 15 further comprising a search field displayed on the graphical user interface, the search field receives the attributes that a user of the graphical user interface wants to search.

20. The instant message system of claim 19 further comprising a second plurality of indicia displayed on the graphical user interface, the second indicia determined based on the attributes entered in the search field.
